(19) United States
(12) Patent Application Publication
(10) Pub. No.: US 2026/0231249 A1
(43) Pub. Date: Aug. 6, 2026

(54) CONDITIONAL CONFIGURATION ACTIVATION FOR SECONDARY ACCESS NODE IN DUAL CONNECTIVITY COMMUNICATION NETWORK

(71) Applicant: Nokia Technologies Oy, Espoo (FI)

(72) Inventors: Suresh P NAIR, Estero, FL (US); Rakshesh P. BHATT, Bangalore (IN); Stawros ORKOPOULOS, Munich (DE); Ranganathan MAVUREDDI DHANASEKARAN, Munich (DE)

(21) Appl. No.: 19/148,425

(22) PCT Filed: Feb. 11, 2024
(86) PCT No.: PCT/IB2024/051266

§ 371 Date: Jul. 16, 2025

(30) Foreign Application Priority Data
Feb. 11, 2023 (IN) 202341008967

(51) Int. Cl. H04W 76/10; H04W 12/03; H04W 12/041; H04W 12/10

(52) U.S. Cl. CPC H04W 76/10; H04W 12/03; H04W 12/041; H04W 12/10

(57) ABSTRACT

Security management techniques are disclosed for conditional configuration activation for at least one secondary node in a multiple radio-dual connectivity communication network environment. For example, a method comprises receiving, at the user equipment, a request from a first access node in a communication network environment to which the user equipment is connected, wherein the received request comprises a conditional configuration associated with a group of two or more secondary access nodes to which the user equipment can connect. The method comprises storing, at the user equipment, the conditional configuration including a security parameter associated with the group of two or more secondary access nodes. The method comprises sending, from the user equipment, a reply to the first access node to indicate the conditional configuration is complete. The method comprises establishing, at the user equipment, a secure connection with a selected one of the two or more secondary access nodes using the security parameter.

### FIELD

The field relates generally to communication networks, and more particularly, but not exclusively, to security management in such communication networks.

### BACKGROUND

This section introduces aspects that may be helpful in facilitating a better understanding of the inventions. Accordingly, the statements of this section are to be read in this light and are not to be understood as admissions about what is in the prior art or what is not in the prior art.

Multi-Radio Dual Connectivity (MR-DC) is a generalization of the Intra Evolved Universal Mobile Telecommunications System (UMTS) Terrestrial Radio Access (Intra-E-UTRA) Dual Connectivity (DC), where multiple receive/transmit (Rx/Tx) capable user equipment (UE) may be configured to utilize resources provided by two different radio access nodes connected via a non-ideal backhaul, e.g., one providing New Radio (NR) access and the other one providing either E-UTRA or NR access. One radio access node acts as the master or main node (MN) and the other radio access node as the secondary node (SN). MN and SN are connected via a network interface and at least the MN is connected to the core network. Also, the MN and/or the SN can be operated with shared spectrum channel access.

However, despite communication benefits that a dual connectivity communication network environment may provide, e.g., UE has more resources for higher throughput, network operators improve mobility robustness and handover management, transition from a 4G communication network to a 5G communication network, added network functionalities, to name a few, significant security management challenges still exist.

### SUMMARY

Illustrative embodiments provide security management techniques for conditional configuration activation for at least one secondary access node in a multiple radio-dual connectivity communication network environment.

In one illustrative embodiment from a user equipment perspective, a method comprises receiving, at the user equipment, a request from a first access node in a communication network environment to which the user equipment is connected, wherein the received request comprises a conditional configuration associated with a group of two or more secondary access nodes to which the user equipment can connect. The method comprises storing, at the user equipment, the conditional configuration associated with the group of two or more secondary access nodes. The method comprises sending, from the user equipment, a reply to the first access node to indicate the conditional configuration is complete. The method comprises establishing, at the user equipment, a secure connection with a selected one of the two or more secondary access nodes.

In another illustrative embodiment from a first access node perspective, a method comprises sending, from the first access node, a request to user equipment connected to the first access node in a communication network environment, wherein the sent request comprises: a conditional configuration associated with a group of two or more secondary access nodes to which the user equipment can connect; and counter data associated with the group of two or more secondary access nodes. The method comprises sending, from the first access node, a request to the two or more secondary access nodes, wherein the sent request comprises an identity and capabilities of the user equipment. The method comprises receiving, at the first access node, a response from one of the two or more secondary access nodes indicating that the user equipment requested a secure connection with the one of the two or more secondary access nodes. The method comprises computing, at the first access node, a security key using the counter data. The method comprises sending, from the first access node, the security key to the one of the two or more secondary access nodes to enable establishment of a secure connection between the user equipment and the one of the two or more secondary nodes.

In yet another illustrative embodiment from a secondary access node perspective, a method comprises receiving a request from a first access node in a communication network environment at one of two or more secondary access nodes, wherein the received request relates to a conditional configuration of user equipment connected to the first access node for establishing a secure connection with a secondary access node, and wherein the sent request comprises an identity and capabilities of the user equipment. The method comprises receiving, at the one of the two or more secondary access nodes, a request from the user equipment requesting a secure connection between the one of the two or more secondary access nodes and the user equipment. The method comprises sending, from the one of the two or more secondary access nodes, a response to the first access node indicating that the user equipment requested a secure connection. The method comprises receiving, at the one of the two or more secondary access nodes, a security key from the first access node. The method comprises establishing, at the one of the two or more secondary access nodes, the secure connection with the user equipment using the security key.

In one non-limiting example, a first access node may be an MN and a secondary access node may be an SN, as mentioned above and otherwise herein.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

Advantageously, illustrative embodiments provide techniques for security management in an MR-DC communication network environment that overcome technical challenges in existing MR-DC communication network environments.

These and other features and advantages of embodiments described herein will become more apparent from the accompanying drawings and the following detailed description.

### BRIEF DESCRIPTION OF THE DRAWINGS

FIG. 1A illustrates control plane connectivity in examples of dual connectivity communication network environments within which illustrative embodiments may be implemented.

FIG. 1B illustrates control plane connectivity in examples of dual connectivity communication network environments within which illustrative embodiments may be implemented.

FIG. 2 illustrates user equipment and network entities with which one or more illustrative embodiments may be implemented.

FIG. 3 illustrates a procedure for addition or modification of a secondary access node in a dual connectivity communication network environment within which illustrative embodiments may be implemented.

FIG. 4 illustrates a procedure for secondary access node key generation in a dual connectivity communication network environment within which illustrative embodiments may be implemented.

FIG. 5 illustrates a procedure for conditional secondary cell group activation for different secondary access nodes according to an illustrative embodiment.

FIG. 6 illustrates a procedure for re-synchronization of secondary access node counter data according to an illustrative embodiment.

FIG. 7 illustrates a procedure for conditional secondary cell group activation for different secondary access nodes according to another illustrative embodiment.

### DETAILED DESCRIPTION

Embodiments will be illustrated herein in conjunction with example communication systems and associated techniques for security management in communication systems. It should be understood, however, that the scope of the claims is not limited to particular types of communication systems and/or processes disclosed. Embodiments can be implemented in a wide variety of other types of communication systems, using alternative processes and operations. For example, although illustrated in the context of wireless cellular systems utilizing 3GPP system elements/functions (more generally, entities) such as ones in 4G and 5G communication networks, the disclosed embodiments can be adapted in a straightforward manner to a variety of other types of communication networks.

In accordance with illustrative embodiments, one or more 3GPP technical specifications (TS) and technical reports (TR) may provide further explanation of network elements/functions and/or operations that may interact with parts of the inventive solutions. For example, one or more illustrative embodiments may be implemented in accordance with details described in TS 33.401 entitled, “3rd Generation Partnership Project; Technical Specification Group Services and System Aspects; 3GPP System Architecture Evolution (SAE); Security Architecture,” and TS 23.501 entitled, “3rd Generation Partnership Project; Technical Specification Group Services and System Aspects; System Architecture for the 5G System (5GS),” the disclosures of which are incorporated by reference herein in their entireties. Other 3GPP TS/TR documents may provide other details that one of ordinary skill in the art will realize. However, while well-suited for 3GPP standards, embodiments are not necessarily intended to be limited to any particular standards.

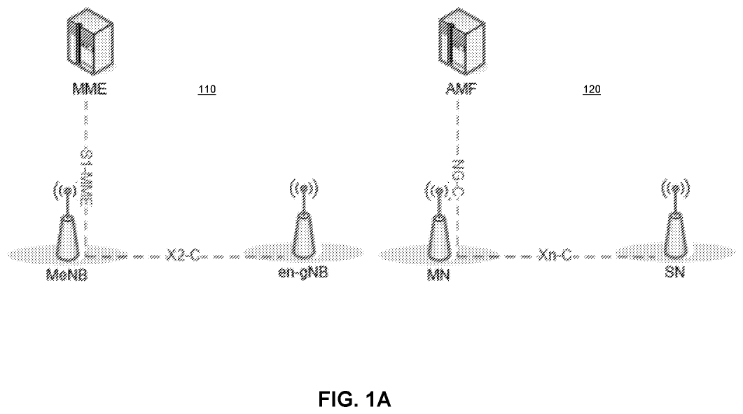

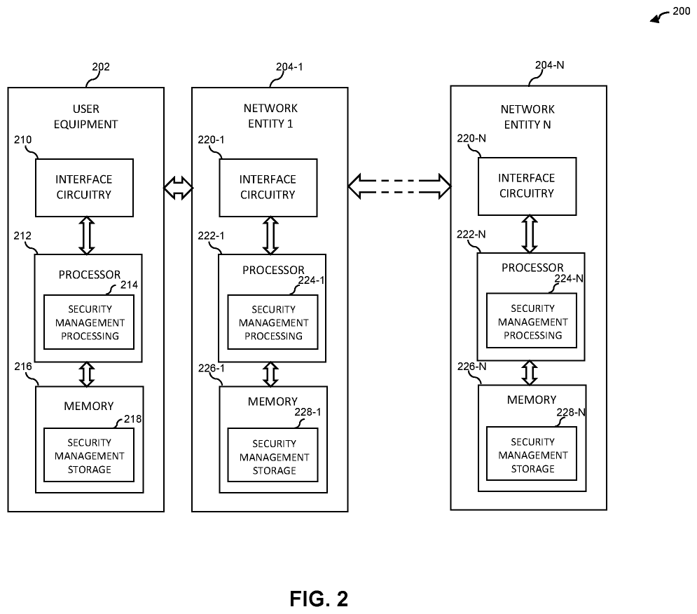

It is to be further understood that the term communication network environment, and the like, in some illustrative embodiments, may be understood to comprise all or part of an access network and/or all or part of a core network. Prior to describing illustrative embodiments, a general description of certain main components of an MR-DC communication network environment will be described below in the context of FIGS. 1A, 1B, and 2.

FIGS. 1A and 1B respectively show examples of control plane (CP) connectivity and user plane (UP) connectivity in an MR-DC communication network environment within which illustrative embodiments are implemented. It is to be understood that the elements shown in FIGS. 1A and 1B are intended to represent some functionalities provided within networks accessed by a user equipment (UE). As such, the elements shown in FIGS. 1A and 1B reference specific elements in 4G/5G networks that provide at least some of these main functionalities. However, other network elements may be used to implement some or all of the main functions represented. Also, it is to be understood that not all functionalities of access and core networks are depicted in FIGS. 1A and 1B. Rather, at least some functionalities that facilitate a better understanding of illustrative embodiments are represented. Subsequent figures may also depict some additional network elements/functions (i.e., network entities).

More specifically, as shown in FIG. 1A, example 110 shows MR-DC CP connectivity with network entities associated with a 4G (Long Term Evolution or LTE) communication network architecture comprising a main access node or base station (MeNB) and a secondary access node or base station (en-gNB). Note that eNB stands for evolved NodeB which is a 4G LTE radio base station (node), while ng-eNB is an upgraded version of a 4G LTE radio base station capable of connecting 4G LTE devices to the 5G core network using the LTE radio interface. Further, a gNB is a 5G radio base station (node). En-gNB is operatively coupled to MeNB via an X2-C interface, while MeNB is operatively coupled to an MME via an S1-MME interface. MME is the network entity in a 4G network that provides access and mobility management for UEs that access the network via MeNB or en-gNB. Thus, a UE (not expressly shown) with MR-DC capabilities would be able to access a 4G core network (e.g., Evolved Packet Core or EPC) via MeNB and/or en-gNB.

As further shown in FIG. 1A, MR-DC example 120 shows MR-DC CP connectivity with network entities in a 5G communication network architecture comprising a main base station or access node MN (main gNB) and a secondary base station or access node SN (secondary gNB). SN is operatively coupled to MN via an Xn-C interface, while MN is operatively coupled to an AMF via an NG-C interface. AMF is the network entity in a 5G network that provides access and mobility management in the control plane for UEs that access the network via MN or SN. Thus, a UE (not expressly shown) with MR-DC capabilities would be able to access a 5G core network (e.g., 5GC) via MN and/or SN.

Turning now to FIG. 1B, example 130 shows MR-DC UP connectivity corresponding to the MR-DC CP connectivity of FIG. 1A. More particularly, MR-DC UP connectivity example 130 represents network entities in a 4G (LTE) communication network architecture comprising an MeNB and an en-gNB, as explained above. En-gNB is operatively coupled to MeNB via an X2-U interface, while MeNB and en-gNB are operatively coupled to an S-GW via an S 1-U interface. S-GW is the network entity in a 4G network that provides interface boundary management in the user plane between the 4G access network (E-UTRAN) and the 4G core network (EPC).

As further shown in FIG. 1B, example 140 shows MR-DC UP connectivity with network entities in a 5G communication network architecture comprising an MN and an SN, as explained above. SN is operatively coupled to MN via an Xn-U interface, while MN and SN are operatively coupled to a UPF via an NG-U interface. UPF is the network entity in a 5G network that provides interface boundary management in the user plane between the 5G access network (5G-RAN) and the 5G core network (5GC).

It is to be understood that a UE (not expressly shown in FIGS. 1A and 1B) with MR-DC capabilities may use one or more types of access nodes to communicate with the same core network or different core networks.

More generally, a UE may comprise a mobile station, and such a mobile station may comprise, by way of example, a mobile telephone, a computer, an IoT device, or any other type of communication device. The term “user equipment” as used herein is therefore intended to be construed broadly, so as to encompass a variety of different types of mobile stations, subscriber stations or, more generally, communication devices, including examples such as a combination of a data card inserted in a laptop or other equipment such as a smart phone. Such communication devices are also intended to encompass devices commonly referred to as access terminals.

In one illustrative embodiment, a UE may be comprised of a Universal Integrated Circuit Card (UICC) part and a Mobile Equipment (ME) part. The UICC is the user-dependent part of the UE and contains at least one Universal Subscriber Identity Module (USIM) and appropriate application software. The USIM securely stores a permanent subscription identifier and its related key, which are used to uniquely identify and authenticate subscribers to access networks. The ME is the user-independent part of the UE and contains terminal equipment (TE) functions and various mobile termination (MT) functions. Alternative illustrative embodiments may not use UICC-based authentication, e.g., a Non-Public (Private) Network (NPN).

Note that, in one example, the permanent subscription identifier is an International Mobile Subscriber Identity (IMSI) unique to the UE. In one embodiment, the IMSI is a fixed 15-digit length and consists of a 3-digit Mobile Country Code (MCC), a 3-digit Mobile Network Code (MNC), and a 9-digit Mobile Station Identification Number (MSIN). In a 5G communication system, an IMSI is referred to as a Subscription Permanent Identifier (SUPI). In the case of an IMSI as a SUPI, the MSIN provides the subscriber identity. Thus, only the MSIN portion of the IMSI typically needs to be encrypted. The MNC and MCC portions of the IMSI provide routing information, used by the serving network to route to the correct home network. When the MSIN of a SUPI is encrypted, it is referred to as Subscription Concealed Identifier (SUCI). Another example of a SUPI uses a Network Access Identifier (NAI). NAI is typically used for IoT communication.

Referring specifically again to a UE with MR-DC capabilities, it is to be appreciated that all functions specified for such a UE may be used for an Integrated Access and Backhaul-Mobile Termination (IAB-MT) unless otherwise stated. Similarly, as specified for a UE with MR-DC capabilities, the IAB-MT can access the network using either one network node or using two different nodes with EN-DC and NR-DC architectures. In EN-DC, the backhauling traffic over the E-UTRA radio interface is not supported. It is to be noted that MR-DC is designed based on the assumption of non-ideal backhaul between the different nodes but can also be used in the case of ideal backhaul. MR-DC procedures as illustratively described herein show an aggregated node case.

Referring now to FIG. 2, a block diagram is shown illustrating computing architectures for various participants in methodologies according to illustrative embodiments. More particularly, system 200 is shown comprising user equipment 202 (e.g., a UE with MR-DC capabilities, as described herein) and a plurality of network entities 204-1, . . . , 204-N. For example, in illustrative embodiments and with reference back to FIGS. 1A and 1B, network entities 204-1, . . . , 204-N can represent access nodes such as, but not limited to, MeNB, en-gNB, MN and SN, as well as core network elements such as, but not limited to, MME, AMF, S-GW and UPF. It is to be appreciated that the UE 202 and network entities 204-1, . . . , 204-N are configured to interact to provide security management and other techniques described herein.

User equipment 202 comprises a processor 212 coupled to a memory 216 and interface circuitry 210. The processor 212 of the user equipment 202 includes a security management processing module 214 that may be implemented at least in part in the form of software executed by the processor. The processing module 214 performs security management described in conjunction with subsequent figures and otherwise herein. Memory 216 of the user equipment 202 includes a security management storage module 218 that stores data generated or otherwise used during security management operations.

Each of the network entities (individually or collectively referred to herein as 204) comprises a processor 222 (222-1, . . . , 222-N) coupled to a memory 226 (226-1, . . . , 226-N) and interface circuitry 220 (220-1, . . . , 220-N). Each processor 222 of each network entity 204 includes a security management processing module 224 (224-1, . . . , 224-N) that may be implemented at least in part in the form of software executed by the processor 222. Processing module 224 performs security management operations described in conjunction with subsequent figures and otherwise herein. Each memory 226 of each network entity 204 includes a security management storage module 228 (228-1, . . . , 228-N) that stores data generated or otherwise used during security management operations.

The processors 212 and 222 may comprise, for example, microprocessors such as central processing units (CPUs), application-specific integrated circuits (ASICs), digital signal processors (DSPs) or other types of processing devices, as well as portions or combinations of such elements.

Memories 216 and 226 may be used to store one or more software programs that are executed by the respective processors 212 and 222 to implement at least a portion of the functionality described herein. For example, security management operations and other functionality as described in conjunction with subsequent figures and otherwise herein may be implemented in a straightforward manner using software code executed by processors 212 and 222.

A given one of the memories 216 and 226 may therefore be viewed as an example of what is more generally referred to herein as a computer program product or still more generally as a processor-readable storage medium that has executable program code embodied therein. Other examples of processor-readable storage media may include disks or other types of magnetic or optical media, in any combination. Illustrative embodiments can include articles of manufacture comprising such computer program products or other processor-readable storage media.

Further, the memories 216 and 226 may more particularly comprise, for example, electronic random-access memory (RAM) such as static RAM (SRAM), dynamic RAM (DRAM) or other types of volatile or non-volatile electronic memory. The latter may include, for example, non-volatile memories such as flash memory, magnetic RAM (MRAM), phase-change RAM (PC-RAM) or ferroelectric RAM (FRAM). The term “memory” as used herein is intended to be broadly construed, and may additionally or alternatively encompass, for example, a read-only memory (ROM), a disk-based memory, or other type of storage device, as well as portions or combinations of such devices.

Interface circuitries 210 and 220 illustratively comprise transceivers or other communication hardware or firmware that allows the associated system elements to communicate with one another in the manner described herein.

It is apparent from FIG. 2 that user equipment 202 and plurality of network entities 204 are configured for communication with each other as security management participants via their respective interface circuitries 210 and 220. This communication involves each participant sending data to and/or receiving data from one or more of the other participants. The term “data” as used herein is intended to be construed broadly, so as to encompass any type of information that may be sent between participants including, but not limited to, identity data, key pairs, key indicators, tokens, secrets, security management messages, registration request/response messages and data, request/response messages, authentication request/response messages and data, metadata, control data, audio, video, multimedia, consent data, other messages, etc. Data may broadly encompass any messages, information, signals, and the like, transferred in a user plane and/or a control plane of a communication network environment.

It is to be appreciated that the particular arrangement of components shown in FIG. 2 is an example only, and numerous alternative configurations may be used in other embodiments. For example, any given network element/function can be configured to incorporate additional or alternative components and to support other communication protocols. Other system elements may each be configured to include components such as a processor, memory and network interface. These elements need not be implemented on separate stand-alone processing platforms, but could instead, for example, represent different functional portions of a single common processing platform. More generally, FIG. 2 can be considered to represent processing devices configured to provide respective security management functionalities and operatively coupled to one another in a communication system.

Given the above general description of some features of a communication network environment, problems with existing security approaches in the context of a UE operating in an MR-DC communication network environment, and solutions proposed in accordance with illustrative embodiments, will now be described herein below.

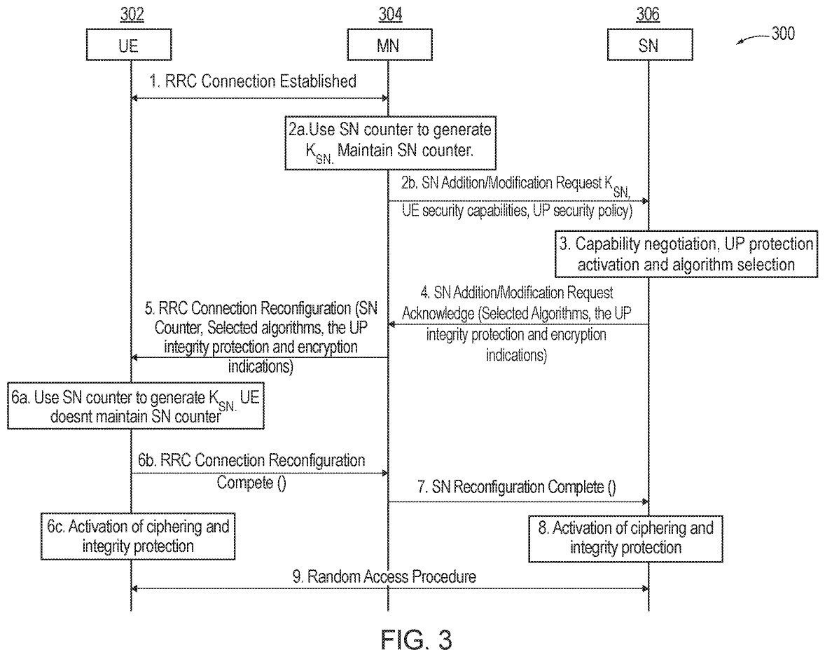

FIG. 3 illustrates a procedure 300 for the addition or modification of an SN in an MR-DC communication network environment. More particularly, as shown, procedure 300 involves a UE 302, an MN 304, and an SN 306. Note that while FIGS. 1A and 1B refer to main nodes as MeNB and MN, and secondary nodes as en-gNB and SN, for ease of reference in the descriptions of procedures to follow, any master or main node (also more generally referred to herein as a first access node) is designated as MN, while any secondary node (also more generally referred to herein as a secondary access node) is designated as SN.

In step 1, UE 302 and MN 304 establish the Radio Resource Control (RRC) connection. UE 302 and MN 304 exchange RRC measurement reports as in any normal RRC connection. When RRC measurement reports indicate an SN to be added, MN 304 initiates step 2 (a. and b.) below.

In step 2a, MN 304 computes and delivers the K_{SN} if a new key is needed.

In step 2b, MN 304 sends an SN Addition/Modification Request message to SN 306, along with K_{SN} if computed in step 2a, over the Xn-C interface to negotiate the available resources, configuration, and algorithms at SN 306. Security capabilities of UE 302 and the user plane (UP) security policy (received from a Session Management Function or SMF) is sent to SN 306. In the case of a Packet Data Unit (PDU) split, a UP integrity protection and ciphering activation decision from MN 304 may also be included.

In step 3, SN 306 allocates the necessary resources and chooses the ciphering algorithm and integrity algorithm which has the highest priority from its configured list and is also present in the UE security capability. If a new K_{SN} was delivered to SN 306, then SN 306 calculates the needed RRC key. The UP keys may be derived at the same time the RRC key is derived. SN 306 activates the UP security policy.

In step 4, SN 306 sends an SN Addition/Modification Acknowledge message to MN 304 indicating availability of requested resources and the identifiers for the selected algorithm(s) for the requested Data Radio Bearers (DRBs) and/or Signaling Radio Bearer (SRB) for UE 302. UP integrity protection and encryption indications are also sent to MN 304.

In step 5, MN 304 sends an RRC Connection Reconfiguration Request message to UE 302 instructing it to configure the new DRBs and/or SRB for SN 306. MN 304 includes the SN Counter parameter to indicate a new K_{SN} is needed. Also, MN 304 forwards the UE configuration parameters, which contain the algorithm identifier(s) received from SN 306, and UP integrity protection and encryption indications to UE 302. Since the message is sent over the RRC connection between MN 304 and UE 302, it is integrity protected using the KRRCint of MN 304. Hence, the SN Counter cannot be tampered with.

In step 6a, UE 302 accepts the RRC Connection Reconfiguration Request message after validating its integrity. UE 302 computes the K_{SN} for SN 306 if an SN Counter parameter was included. UE 302 also computes the needed RRC and UP keys and activates the RRC and UP protection as per the indications received for the associated SRB and/or DRBs, respectively.

In step 6b, UE sends the RRC Reconfiguration Complete message to MN 304.

In step 6c, UE 302 activates the chosen encryption/decryption and integrity protection with SN 306.

In step 7, MN 304 sends the SN Reconfiguration Complete message to SN 306 over the Xn-C interface to inform SN 306 of the configuration result. If the security key K_{SN} was not sent in step 2a to SN 306, K_{SN} is also included in this step.

In step 8, upon receipt of the SN Reconfiguration Complete message, SN 306 may activate the chosen encryption/decryption and integrity protection with UE 302. If SN 306 does not activate encryption/decryption and integrity protection with UE 302 at this stage, SN 306 activates encryption/decryption and integrity protection upon receiving a Random Access request message from UE 302 in a random access procedure in step 9 after identifying UE 302 using the unique preamble of UE 302.

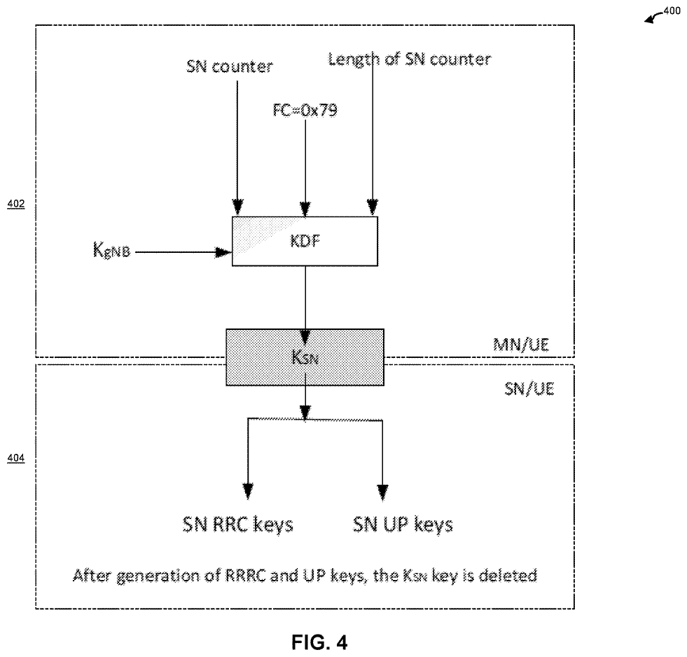

FIG. 4 illustrates a procedure 400 for SN key generation from the perspective of MN 304/UE 302 in block 402 and the perspective of SN 306/UE 302 in block 404. More particularly, MN 304 maintains a 16-bit counter, i.e., SN Counter, in its Access Stratum (AS) security context. The SN Counter is used when computing the K_{SN} key. MN 304 maintains the value of the SN Counter for a duration of the current 5G AS security context between UE 302 and MN 304. UE 302 does not need to maintain the SN Counter after it has computed the K_{SN} key since MN 304 provides UE 302 with the current SN Counter value when UE 302 needs to compute a new K_{SN} key. The SN Counter is a fresh input to the K_{SN} derivation process. That is, UE 302 assumes that MN 304 provides a fresh SN Counter each time and does not need to verify the freshness of the SN Counter.

An attacker cannot, over the air, modify the SN Counter and force re-use of the same SN Counter. The reason for this is that the SN Counter is delivered over the RRC connection between MN 304 and UE 302, and this connection is both integrity protected and protected from replay.

UE 302 and MN 304 derive the security key K_{SN} of SN 306 as described above. The SN RRC and UP keys are derived from the K_{SN} key both at SN 306 and UE 302 using the function given in Annex A. 7 of the above-referenced TS 33.401 if SN 306 is a ng-eNB or using the function given in Annex A. 8 of the above-referenced TS 33.501 if SN 306 is a gNB.

Once all the SN RRC and UP keys have been derived from the K_{SN} key, SN 306 and UE 302 may delete the K_{SN} key.

In an MR-DC communication network environment, there is a master or main cell group (MCG) with each cell in the MCG having a base station or access node (such as, e.g., MN 304 above), and a secondary cell group (SCG) with each cell in the SCG having a base station or access node (such as, e.g., SN 306 above). The cell in the MCG used to establish initial access for UE 302 is referred to as a PCell. The cell being used for access for UE 302 in the SCG is called a PSCell. Note that a given MN may control more than one cell in an MCG, and similarly, a given SN may control more than one cell in an SCG.

It has been proposed by RAN2 (RAN2 is responsible for the development of specifications dealing with E-UTRAN and NR radio access) to have selective SCG activation in which the UE remains connected to the same PCell and is configured with several conditional reconfigurations (a conditional reconfiguration is specified in an RRC reconfiguration message, possibly including the SN Counter, e.g., see FIG. 3 description above), each with a different candidate target PSCell. Based on conditions of measurement results on candidate target PSCells, the UE selects and executes one of these conditional reconfigurations, thus changing PSCells.

After executing a conditional reconfiguration, the UE may maintain conditional reconfigurations to the other candidate target PSCells and continue switching between the candidate target PSCells multiple times, including to an earlier selected PSCell. All of this happens without any reconfiguration by the network (i.e., using the stored conditional reconfigurations). The candidate target PSCells may be controlled by different SNs, so the execution of a conditional reconfiguration will sometimes change the serving SN. The serving SNs may have different Packet Data Convergence Protocol (PDCP) anchor points.

As such, it would be advantageous that the following scenarios be supported:
(i) The UE changes to PSCell #1a controlled by SN #1, then to PSCell #2a controlled by SN #2, then to PSCell #1a controlled by SN #1.
(ii) The UE changes to PSCell #1a controlled by SN #1, then to PSCell #2a controlled by SN #2, then to PSCell #1b controlled by SN #1.

It is realized herein that, with existing procedures:
(i) The UE derives the S-KgNB (K_{SN} key) from the SN Counter in the executed conditional reconfiguration, if included.
(ii) In the above scenarios, the UE will use the same S-KgNB every time it is connected to PSCell #1a, i.e., before and after moving to SN #2.
(iii) If the same value of the SN Counter is included in the conditional reconfiguration for PSCell #1a and in the conditional reconfiguration for PSCell #1b, the UE will use the same S-KgNB before and after moving to SN #2.

In the above-referenced TS 33.501, dual connectivity covers only the scenario of MN initiated dual connectivity. It does not cover the conditional dual connectivity where the UE is provisioned to select secondary nodes automatically without frequent RRC signaling with the MN. In the new scenario, the UE is provisioned with parameters necessary for the conditional selection of the PSCell. Along with this, the UE needs to know how to establish security automatically with the selected PSCell.

Illustrative embodiments address the security part of conditional SCG addition, particularly the SN counter handling, computation of K_{SN} by the UE and the MN, and how and when the MN sends the K_{SN} to the PSCell.

More particularly, in accordance with one or more illustrative embodiments, the MN configures an SCG counter mode to either monotonic or specific values in the UE (per PSCell per connection). These counter modes are stored in the UE and the MN for future references. Further, the MN indicates, to all the SNs of the SCG, the UE's preamble (allocated for RACH procedure with specific SN) or UE identifier (ID), and security capabilities supported by the UE. When the UE starts the Random-Access Channel (RACH) procedure to the SN, then the SN contacts the MN to fetch the new SN key (generated using the SN Counter). The UE also generates new SN keys. Both the UE and the SN further communicate with generated SN keys (i.e., RRC and UP keys).

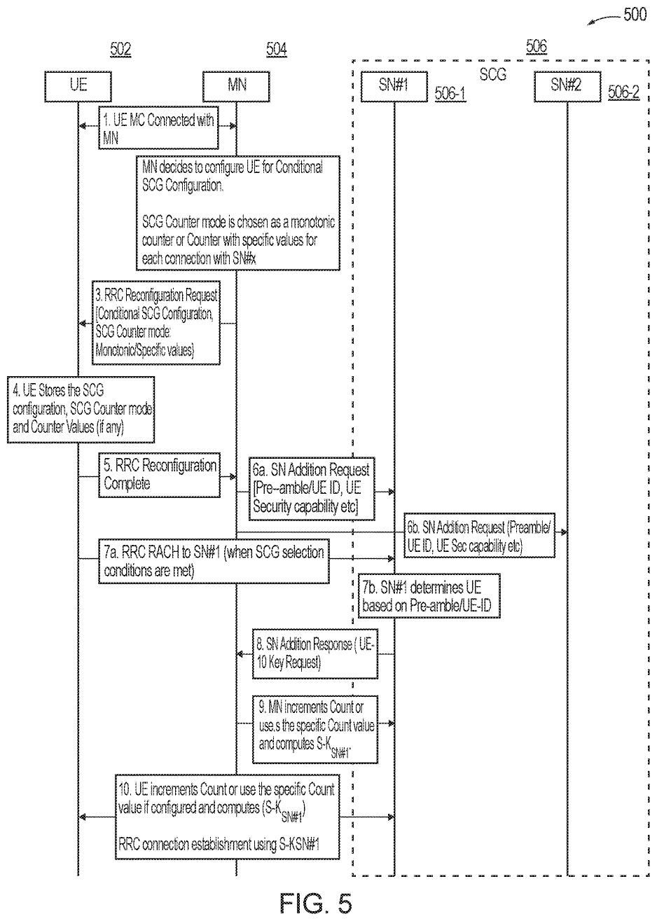

FIG. 5 illustrates a procedure 500 for conditional SCG activation for different secondary nodes (SNs) according to an illustrative embodiment. As shown, procedure 500 involves a UE 502, an MN 504, and an SCG 506 comprising a first SN 506-1 (SN #1) and a second SN 506-2 (SN #2).

In step 1, the RRC connection is established between UE 502 and MN 504.

In step 2, MN 504 decides to configure UE 502 for conditional SCG configuration. MN 504 could chose either a monotonic counter or counter with specific values for each connection with SN#x. “x” here in represents different SNs, e.g., SN#1, SN#2 . . . SN#x, in this example, first SN 506-1 and second SN 506-2.

In step 3, MN 504 sends an RRC reconfiguration request message with conditional SCG configuration with the SCG counter mode set to either monotonic or specific values.

In step 4, UE 502 stores the conditional SCG configuration along with SCG counter mode set to either monotonic or specific values (if any set by MN 504).

In step 5, UE 502 sends an RRC connection reconfiguration complete message to MN 504 indicating that configuration is successful.

In step 6 (a. and b.), MN 504 sends an SN addition request message to each SN (first SN 506-1 and second SN 506-2) with a pre-amble or UE ID, UE security capabilities, etc.

Note that steps 1 through 6 are the configuration phase of the conditional SCG procedure at first SN 506-1, second SN 506-2, and UE 502. No SN keys are generated at first SN 506-1, second SN 506-2, and UE 502 until MN 504 first does so.

In step 7 (a. and b.), UE 502 sends a RACH request message to first SN 506-1 when the SCG selection condition is met. First SN 506-1 determines UE 502 based on the preamble or UE ID received.

In step 8, first SN 506-1 sends an SN addition response message with a UE ID key and a UE key material request to MN 504.

In step 9, MN 504 increments the count or uses a specific count value to compute the secondary node key S-KSN#1. The generated key is sent to first SN 506-1.

In step 10, UE 502 also (similar to first SN 506-1 at step 9) increments the count or uses a specific count value to compute secondary node key S-KSN#1. RRC connection establishment uses the generated secondary node key S-KSN#1.

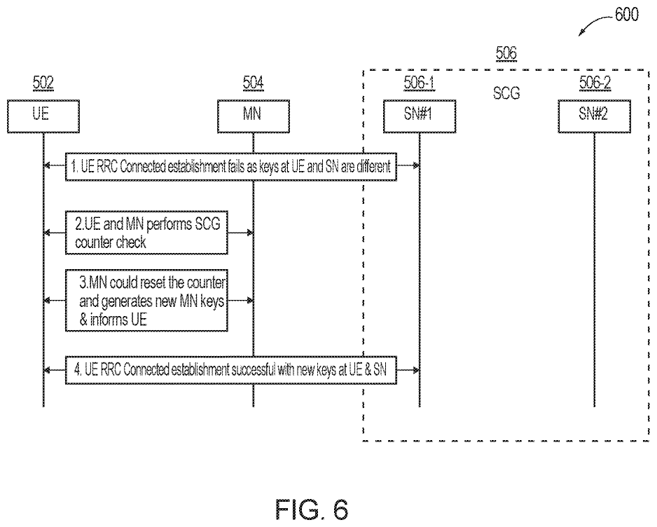

There could be a possibility of mis-synchronization between UE key generation and MN key generation for a specific SN. FIG. 6 illustrates a procedure 600 for re-synchronization (re-sync) of the SN counter according to an illustrative embodiment.

As shown in procedure 600, in step 1, it is assumed that step 10 in procedure 500 of FIG. 5 fails because the key used to integrity protect or cipher the messages at UE 502 and first SN 506-1 might be different due to different SN counters used.

In this case, in step 2, UE 502 and MN 504 use a procedure for the SCG counter check, over the RRC connection between MN 504 and UE 502.

In step 3, MN 504 generates new MN keys and resets the counter. The same configuration is sent to UE 502 and thus the new keys are generated at UE 502 with new MN keys.

In step 4, MN 504 also generates SN keys and sends to first SN 506-1, so the RRC connection establishment is successful with the newly generated key. With this approach, the counter re-sync issue is solved.

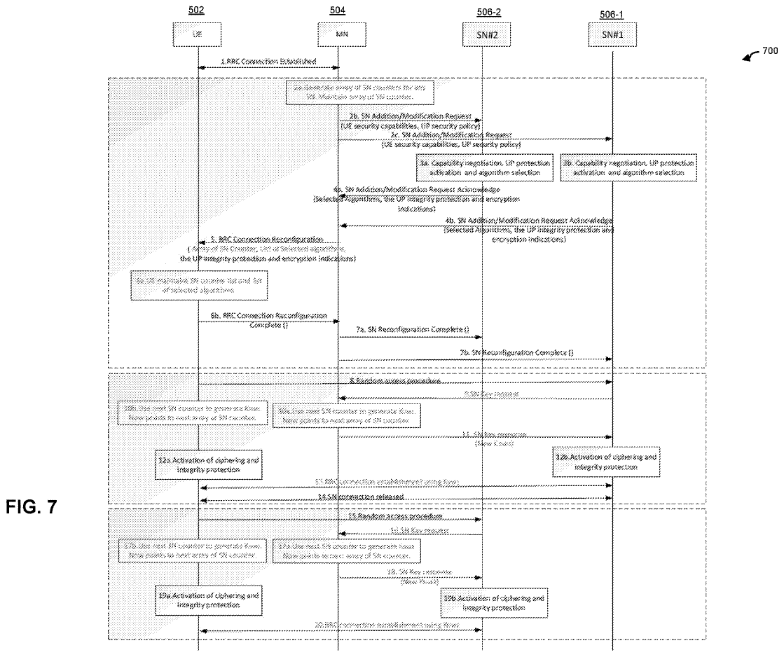

FIG. 7 illustrates a procedure 700 for conditional SCG activation for different secondary nodes (SNs) according to another illustrative embodiment. For ease of reference, procedure 700 is illustratively assumed to involve the same UE, i.e., UE 502, and network entities, i.e., MN 504, first SN 506-1 (SN #1), and second SN 506-2 (SN #2), as referenced in FIG. 5. However, it is to be understood that a UE and/or network entity can be configured to perform the steps of procedure 500, procedure 600, procedure 700, or some combinations of procedures 500, 600, and 700, as needed or otherwise appropriate.

In step 1, the RRC connection is established between UE 502 and MN 504.

In step 2 (a., b., c.), MN 504 sends an SN Addition/Modification Request message to all the SNs configured with MN 504, in this example, first SN 506-1 and second SN 506-2, over the Xn-C interface to negotiate the available resources, configuration and algorithm at each SN. The security capabilities of UE 502 and the UP security policy received from the SMF are also sent to first SN 506-1 and second SN 506-2.

In step 3 (a. and b.), each of first SN 506-1 and second SN 506-2 allocates the necessary resources and chooses the ciphering algorithm and integrity algorithm which has the highest priority from its configured list and is also present in the UE security capabilities.

In step 4 (a. and b.), each of first SN 506-1 and second SN 506-2 sends an SN Addition/Modification Acknowledge message to MN 504 indicating availability of the requested resources and the identifiers for the selected algorithm(s) for the requested DRBs and/or SRB for UE 502. UP integrity protection and encryption indications are also sent to MN 504.

In step 5, MN 504 sends an RRC connection reconfiguration request message to UE 502 with a list of SN counters and a list of selected algorithms, UP protection, and encryption indications. This message is protected with the RRC integrity keys of MN 504.

In step 6 (a. and b.), UE 502 verifies the integrity of the received RRC connection reconfiguration with the RRC integrity keys of MN 504. UE 502 maintains the SN counter list and the list of selected algorithms of the different SNs, i.e., first SN 506-1 and second SN 506-2. UE 502 sends an RRC Reconfiguration Complete message to MN 504.

In step 7 (a. and b.), MN 504 sends an SN Reconfiguration Complete message to each of first SN 506-1 and second SN 506-2 over the Xn-C interface to inform the SN of the configuration result.

In step 8, UE 502 starts a RACH procedure with first SN 506-1 directly using its UE ID.

In step 9, first SN 506-1 sends a key request to MN 504.

In step 10 (a. and b.), MN 504 uses the SN counter to generate KSN#1. Then, first SN 506-1 increments the list to point to a next one in the list of SN counters. UE 502 also similarly generates a key for first SN 506-1.

In step 11, MN 504 sends an SN key response message to first SN 506-1 with the newly generated KSN#1.

In step 12 (a. and b.), UE 502 and first SN 506-1 also compute the needed RRC and UP keys and activate the RRC and UP protection as per the indications received (at step 5) for the associated SRB and/or DRBs, respectively. First SN 506-1 and UE 502 activate the chosen encryption/decryption and integrity protection keys at this point.

In step 13, RRC connection establishment and further communication uses the key KSN #1.

In step 14, the SN connection is released.

In steps 15 through 20, these steps are similar to steps 8 through 14 but for second SN 506-2.

As used herein, it is to be understood that the term “communication network” in some embodiments can comprise two or more separate communication networks. Further, the particular processing operations and other system functionality described in conjunction with the diagrams described herein are presented by way of illustrative example only and should not be construed as limiting the scope of the disclosure in any way. Alternative embodiments can use other types of processing operations and messaging protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It should again be emphasized that the various embodiments described herein are presented by way of illustrative example only and should not be construed as limiting the scope of the claims. For example, alternative embodiments can utilize different communication system configurations, user equipment configurations, base station configurations, provisioning and usage processes, messaging protocols and message formats than those described above in the context of the illustrative embodiments. These and numerous other alternative embodiments within the scope of the appended claims will be readily apparent to those skilled in the art.

1-27. (canceled)

28. A user equipment comprising:
at least one processor; and
at least one memory storing instructions that, when executed by the at least one processor, cause the user equipment at least to perform:
receiving a request from a first access node in a communication network to which the apparatus is connected, wherein the request comprises a configuration associated with a group of two or more secondary access nodes to which the apparatus can connect;
configuring the user equipment with the configuration associated with the group of two or more secondary access nodes;
sending, to the first access node, a reply to the request, the reply indicating the configuring is finished; and
establishing a secure connection with a selected one of the two or more secondary access nodes in accordance with the configuration after the configuring is finished.

29. The user equipment of claim 28, wherein the configuration comprises a list of counter data arrays associated with the group of two or more secondary access nodes to be used in connections.

30. The user equipment of claim 29, wherein, for a monotonic counter mode of the user equipment, the list of counter data arrays comprises a single counter value to initiate a counter or a mode to indicate how to maintain the counter at the user equipment.

31. The user equipment of claim 29, wherein the list of counter data arrays comprises a respective counter value for each of the two or more secondary access nodes in the group.

32. The user equipment of claim 29, wherein the instructions, when executed by the at least one processor, further cause the user equipment to:
perform a counter data check with the first access node; and
perform a reset of the counter data arrays with the first access node when a mis-synchronization issue is detected during the counter data check.

33. The user equipment of claim 29, wherein, when establishing a secure connection with one or more of the two or more secondary access nodes, the instructions, when executed by the at least on processor, further cause the user equipment to compute a security key for at least one secondary access node of the two or more secondary access nodes using the counter data arrays.

34. The user equipment of claim 28, wherein, when establishing a secure connection with one or more of the two or more secondary access nodes, the instructions, when executed by the at least one processor, further cause the user equipment to release the secure connection with the one of the two or more secondary access nodes before establishing a secure connection with another of the two or more secondary access nodes.

35. The user equipment of claim 29, wherein the configuration comprises indicators of one or more security algorithms.

36. The user equipment of claim 35, wherein the one or more security algorithms comprise at least one of an integrity protection algorithm or an encryption algorithm.

37. The user equipment of claim 35, wherein, when establishing a secure connection with one or more of the two or more secondary access nodes, the instructions, when executed by the at least on processor, further cause the user equipment to select and activate at least one of the one or more security algorithms.

38. The user equipment of claim 29, wherein the list of counter data arrays comprises respective values for each of PSCell or each of connection.

39. A method of a user equipment, the method comprising:
receiving a request from a first access node in a communication network to which the user equipment is connected, wherein the request comprises a configuration associated with a group of two or more secondary access nodes to which the user equipment can connect;
configuring the configuration associated with the group of two or more secondary access nodes;
sending, to the first access node, a reply to the request, the reply indicating the configuring is finished; and
establishing a secure connection with a selected one of the two or more secondary access nodes in accordance with the configuration after the configuring is finished.

40. The method of claim 39, wherein the configuration comprises a list of counter data arrays associated with the group of two or more secondary access nodes to be used in connections.

41. The method of claim 40, wherein the list of counter data arrays comprises a specific counter value for each of the two or more secondary access nodes in the group.

42. The method of claim 40, wherein the list of counter data arrays comprises respective values for each of PSCell or each of connection.
